(19) United States
(12) Patent Application Publication
(10) Pub. No.: US 2003/0074498 A1
(43) Pub. Date: Apr. 17, 2003

(54) Method and circuitry for a programmable controller system

(76) Inventors: Ronald E. Gareis, Charlottesville, VA (US); Don Gates, Charlottesville, VA (US)

Correspondence Address: KENNETH E. HORTON, RADER, FISHMAN & GRAUER PLLC, RIVERPARK CORPORATE CENTER ONE, 10653 SOUTH RIVERFRONT PARKWAY, SUITE 150, SOUTH JORDAN, UT, 84095, US

(21) Appl. No.: 09/978,530

(22) Filed: Oct. 16, 2001

(51) Int. Cl. G06F 3/00

(52) U.S. Cl. 710/36

(57) ABSTRACT

The invention disclosed is useful in an I/O system of a programmable controller and provides a method and circuitry by which control and diagnostic information is exchanged between a control unit of an I/O module and a plurality of input/output points of the I/O module. A control signal is generated in the control unit in the form of sequential pulse frames such that the control information is defined by a series of pulse width modulated pulses. Each frame includes a no-pulse time period following the review of pulses to mark the end of a frame. Each I/O point receives a control signal of its own and generates a clock pulse in response to each pulse. The clock pulse initiates a sampling of the corresponding pulse and simultaneously initiates return of a diagnostic signal value to the central unit by implementation of firmware in a switch processor. Thus, the control signal provides for sampling of its own content and provides for a return of a diagnostic data bit for each control bit.

### FIELD OF THE INVENTION

The present invention relates in general to methods and apparatus for use with programmable controllers; and in particular to an intelligent input/output system therefore.

### BACKGROUND OF THE INVENTION

Process control with a programmable controller involves the acquisition of input signals from various process sensors and the provision of output signals to controlled elements of the process. The process is thus controlled as a function of a stored program and of process conditions as reported by the sensors. Numerous and diverse processes are, of course, subject to such control, and sequential operation of industrial processes, conveyor systems, and chemical, petroleum, and metallurgical processes may all, for example, be advantageously controlled by programmable controllers.

Programmable controllers are of relatively recent development. A state of the art programmable controller comprises a central processing unit (CPU) made up, broadly, of a computer processor for executing the stored program a memory unit of sufficient size to store the program and the data relating to the status of the inputs and outputs, and one or more power supplies. In addition, an input/output (I/O) system provides the interface between the central processing unit and the input devices and controlled elements of the process being controlled.

Input/output systems have remained relatively unchanged since the advent of programmable controllers and are the feature most in need of improvement. While some advances have been made in I/O systems, the improvements have generally been along the same lines as those followed in the past. For example, U.S. Pat. No. 4,293,924 describes an I/O system wherein the density of the interface is increased. Another approach, illustrated by U.S. Pat. No. 4,247,882, has been to concentrate on improving the housing for the input/output system. With the increased complexity of the processes requiring control, and with a need for a greater exchange of information between the process and the central processor, however, other improvement approaches to I/O problems have been needed.

The conventional I/O system is composed of a number of individual I/O points, each one of which is devoted to either receiving the signal from an input device (e.g., a limit switch, pressure switch, etc.) or to providing a control signal to an output device (e.g., a solenoid, motor starter, etc.), depending on how the circuitry for the particular I/O point is configured. That is, an I/O point is dedicated to being either an input point or an output point and is not readily converted from one use to the other.

One problem with state of the art I/O systems (particularly when used with a complex process) is the high cost of installation. Typically, I/O modules, or circuit cards, are housed in card racks or cages. For control of an extensive or complex process, a large number of I/O points must be provided in each rack or cage. This necessarily entails a great deal of wiring expense (both for labor and for materials) since wires from all of the input and output devices must be brought into the I/O rack.

Additional problems then arise from use of a large I/O rack since it is frequently difficult to bring all of the wires into the rack to make the terminations. Although it is well-known to provide at least a portion of an I/O system in an enclosure or rack remote from the CPU (in an attempt to get the I/O closer to the process being controlled), these problems are still not overcome since there is a concentration of input/output wiring into a single (albeit remote) location. Further complications arise in dissipating heat in a concentrated I/O system and, for that reason, it is frequently necessary to operate an I/O system at less than its optimum rating.

Another problem with present I/O systems is that they are difficult to diagnose and troubleshoot—whether the malfunctions occur in the programmable controller, per se, or in the controlled process. Experience has shown that most on-line failures associated with a controller occur in the I/O system. The CPU portion is now highly refined, having benefited greatly from the advances in microprocessor technology and data processing, for example. When an electrical failure does occur, however, early detection and diagnosis of the precise nature of the problem is often critical. It is naturally desirable to detect a failed part through an advanced warning rather than after some part of the process is out of control.

With state of the art I/O systems, early detection or failures is difficult, and even when a failure is signaled its precise location and nature may not be apparent. In many cases it is even difficult to separate controller I/O failures from failed elements (e.g., motors, pushbuttons, etc.) in the process. Diagnostic features, particular for the controller I/O system, have simply been lacking. Improvements for diagnosing and preventing I/O system failures have therefore been eagerly sought.

The problem of diagnosing failures is at times made difficult because each I/O point is ordinarily protected by a fuse. Although the fuse protects the particular I/O module from overcurrent, frequently it adds to the problem. For example, mere transient current may blow the fuse, leaving the I/O point completely inoperative until the failed point can be located and the fuse replaced.

Somewhat related is the problem of exchanging diagnostic and control information between a controlling portion and a controlled portion of an I/O system. For example, it may occur that distributed I/O modules are used to configure an I/O system. In such case it is desirable to provide simple, reliable means and methods for exchanging such information.

Yet another drawback of conventional I/O systems is that (as was mentioned above) each I/O point functions strictly as an input point or as an output point. The same point may not readily be converted from one use to the other. The user of a programmable controller is therefore required to select input and output functions separately, based on an initial estimate of needs. There is a decided lack of flexibility for unforeseen future needs. Moreover, since I/O points are typically available in groups (e.g., six or eight points per circuit card), there is frequently a large number of unused I/O points in a control system.

Accordingly, the principal object of the present invention is to provide an input/output system which overcomes these shortcomings of conventional I/O systems. More particularly, however, it is sought to provide an I/O system wherein each I/O point may be selected to operate either as an input point or as an output point.

In addition, it is sought to provide an input/output system wherein each I/O point is self-protected against overcurrent and overvoltage conditions without the use of fuses or circuit breakers and wherein each I/O point is continuously and automatically diagnosed for failure, both within the I/O system and within the controlled process, and wherein detected failures are identified and automatically reported. A further, specific object of the invention is to provide an I/O system which is simple and economical to wire and use and which provides individual I/O points in distributed groups, or modules, for location in close proximity to the process, or particular part of the process to be controlled. An additional object of the invention is to provide an I/O system which includes means for monitoring, controlling, and troubleshooting each I/O point independent of the conventional central processor unit. Still further objects, features, and advantages of the invention will appear from the ensuing detailed description.

### SUMMARY OF THE INVENTION

The present invention meets the above-described needs and others. Specifically, the present invention provides, in an input/output (I/O) system of a programmable controller, a communications method and I/O circuit for exchanging information on control and operating parameters between a controlling element of the I/O system and a controlled element thereof which includes an output control device activated and deactivated in accordance with the control information, including the steps of: generating in the controlling element a control signal in the form of sequential pulse frames, each frame having at least one control pulse defining said control information; transmitting the control signal to the controlled element and generating in the controlled element a clock pulse for each control pulse such that the clock pulse follows the control pulse by a pre-selected time interval on each frame, there being one clock pulse for each control pulse such that there is a fixed time relationship between each control pulse and each clock pulse; generating in the controlled element a diagnostic signal independent of the control signal but which is indicative of operating parameters of the controlled element; and using the clock pulse on each frame to cause a sampling of the control information and to cause a transmission of a value of the diagnostic signal to the controlling element, wherein the I/O circuit comprises a switch processor, a plurality of signal conditioning circuits, and a switch section. Each frame of the control signal may further include a no-pulse time interval during which no pulses appear defining the end of a frame. Each frame of the control signal may also include a series of pulses defining the control information. The series of pulses may include two to six pulses, followed by the no-pulse time interval. The no-pulse time interval may include a missing pulse for synchronizing the control and diagnostic signals.

In some embodiments a first two of the two to six pulses are redundant pulses representing an ON/OFF command. A third and fourth of the two to six pulses may represent control information. A fifth and sixth of the two to six pulses may represent diagnostic information.

In some embodiments the series of pulses is pulse width modulated. The diagnostic signal may include a multi-bit digital signal and the number of bits transmitted to the controlling element on each frame may equal the number of pulses in the series of pulses in the same frame, with the multi-bit digital signal being determined by firmware loaded on the switch processor.

According to one aspect of the invention there is disclosed an input/output (I/O) circuit comprising a switch processor, a plurality of signal conditioning circuits, and a switch section processor, wherein the switch section processor comprises firmware programmed to accept signals from the conditioning circuits as data inputs, the data inputs comprising inputs to firmware algorithms for generating diagnostic signals. The signals accepted as inputs to the firmware may include a series of two to six pulses. The switch processor may include a zero crossing turn-on and turn-off feature, wherein the switch processor waits until a zero crossing of voltage before turning the switch section on, and a zero crossing of current before turning the switch section off. The switch processor may include an analog-to-digital converter circuit for converting signals to a form usable by the firmware. The switch processor may receive a signal representative of the switch section current. The switch processor may also causes the switch to be turned off immediately upon detection of a first threshold current level.

In some embodiments the switch processor may cause the switch to be turned off after a predetermined period of time during which the switch processor detects a switch current level of a second threshold level, the second threshold level being lower than the first threshold level.

In some embodiments the switch processor may report an overcurrent diagnostic signal, but does not turn off the switch, upon detection of a switch current level of a third threshold level, the third threshold level being lower than the second threshold level.

According to one aspect of the invention, the firmware of the switch processor generates diagnostic codes for one or more of: over temperature conditions, short circuit conditions, over current conditions, low voltage conditions, and high voltage conditions based on input signals from the conditioning circuits.

According to one aspect of the invention there is disclosed an input/output (I/O) system of a programmable controller, an input/output mode including: an operations control unit including a switch processor for providing a control signal in the form of sequential pulse frames, each frame having at least one control pulse defining a desired control status; and at least one I/O point connected to the operations control unit and having an output control device subject to activation and deactivation as an operative condition in accordance with the control status and further including: (1) timing means responsive to each control pulse to generate a clock pulse which follows the control pulse by a pre-selected time interval on each frame, there being one clock pulse for each control pulse such that there if a fixed time relationship between such pulses; (2) firmware located on the switch processor and connected to the I/O point for providing a diagnostic signal having a value indicative of the operative condition of the I/O point; (3) means connected to receive each clock pulse and responsive to each clock pulse on each frame to cause a sampling of each control pulse to determine the desired control status; and (4) means connected to receive each clock pulse and the diagnostic signal and responsive to the clock pulse on each frame to cause a transmission of a value of the diagnostic signal to the operations control unit. The operations control unit may provide the control signal such that each frame includes a series of pulses followed by a no-pulse time interval during which no pulses occur, the no-pulse time interval defining the end of a frame. At least the first two pulses of each frame may be pulse width modulated redundantly to determine the control status.

According to one embodiment of the invention there is disclosed, in a programmable controller input/output system of the type having a plurality of input/output modules, each adapted to be located in proximity to a process being controlled, circuitry for use in such modules, including: output control means responsive to be activated and deactivated by a command signal; an operations controller generating at least one control signal in the form of sequential pulse frames, each frame of which contains at least one pulse defining a control status for the output control means and a time interval without pulses defining the end of the frame whenever the interval reaches a first pre-selected time duration; a communications and control section receiving the control signal and including firmware responsive to the at least one pulse to provide the command signal for activating and deactivating the output control means in accordance with the control status for each frame and means responsive to the time interval for synchronizing operation of the communications and control section with each frame; sensing means providing status signals indicative of the operative condition of the output control means; and wherein the communications and control section includes a switch processor with on-board firmware coding for receiving the status signals and responsive thereto to produce a diagnostic signal which is updated on each frame of the control signal and first selector means for transmitting the diagnostic signal to the operations controller on each frame of the control signal. Each frame of the control signal may contain a series of pulses defining the control status. At least the first two pulses of each frame may be pulse width modulated redundantly to determine the command signal for activating and deactivating the output control means. The communications and control section may further include second selector means responsive to the time interval to cause the output control means to assume a pre-selected state whenever the time duration of the interval reaches a second preselected value. This embodiment of the invention may include a plurality of output control means and a corresponding plurality of communications and control sections, each with a switch processor, and wherein the operations controller generates a plurality of control signals providing one control signal for each communications and control section.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a simplified block diagram of a programmable controller system including an intelligent input/output (I/O) system in accordance with the present invention;

FIG. 2 is a perspective illustration of one embodiment for an individual I/O module and a hand-held monitor, both configured for use in the I/O system of FIG. 1;

FIG. 3 is a block diagram illustrating in greater detail one of the I/O modules of FIG. 1;

FIG. 4 is a circuit diagram of a communications section and a control and sensing section for an I/O point of the type illustrated in FIG. 3;

FIGS. 5 and 6 are illustrations of waveforms showing the relationship between certain signals relevant to the circuitry of FIG. 4;

FIG. 7 is a truth table relating diagnostic and status data to a four bit coded signal for providing combinatorial logic in a state encoder for the switch processor section of FIG. 4.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such a development effort might be complex and time-consuming, but would nevertheless be a routine undertaking for those of ordinary skill in the art having the benefit of this disclosure.

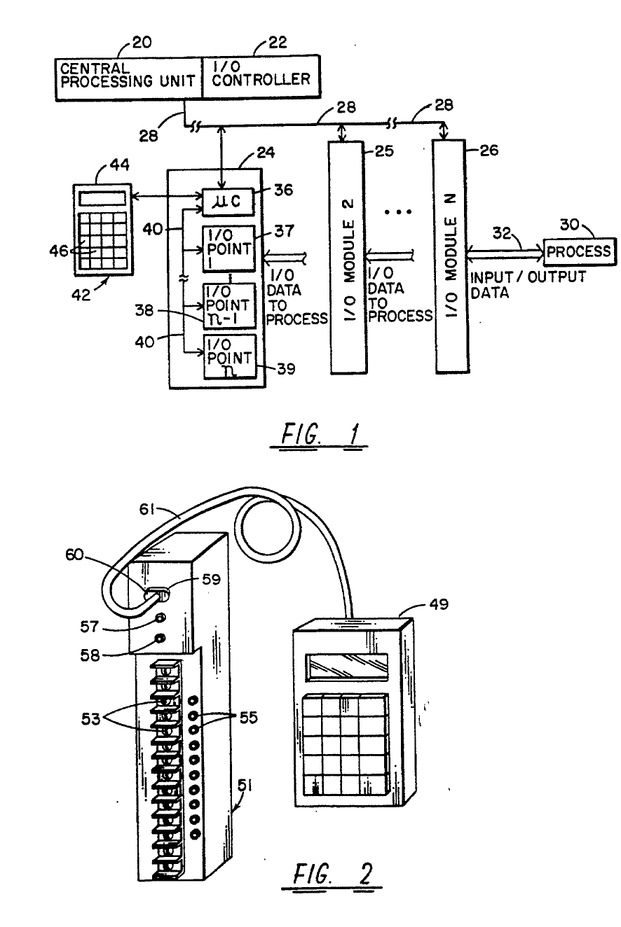

Turning now to the figures, the programmable controller of FIG. 1 includes a central processing unit (CPU) 20, an input/output (I/O) controller 22, a plurality of input/output modules 24-26, and a data communications link 28 which interconnects each I/O module 24-26 with the I/O controller 22 These items, exclusive of CPU 20, generally comprise the input/output system of the controller. The CPU 20 is substantially of conventional design and may include one or more microprocessors for data handling and control, plus memory for storage of operating programs, input/output data, and other computed, interim, or permanent data for use in executing the stored program and for implementation of control. In addition, other conventional elements, such as power supplies, are included as necessary to make the CPU 20 fully functional. The I/O controller 22 provides for control of information exchanged between the various I/O modules 24-26 and the CPU 20.

Each I/O module 24-26, may be separately located, remote from CPU 20 and I/O controller 22, and in close proximity to the process being controlled. Although only three I/O modules are illustrated in FIG. 1, it will be understood that the actual number may be considerably greater. For example, sixteen separate I/O modules may be readily accommodated in the system to be described herein. Each I/O module is independent of the other and each may be devoted to control of a process separate from that controlled by all other I/O modules.

In FIG. 1, for example, the Nth I/O module 26 is illustrated to control a generalized process 30. The input and output signals associated with process 30 are conveyed by conductors 32 which run between the process 30 and the I/O module 26. The process 30 may, of course, take virtually any form. In any case, however, it includes various sensors, switches, etc. (not specifically illustrated) for sensing the status and condition of the process 30. The information from the process is in the form of input signals to I/O module 26. The process 30 also includes controlled elements (e.g., pumps, motors, etc.—also not illustrated) which receive the output signals from the I/O module 26 and which thereby effect control of the process 30. In similar fashion each of the other I/O modules 24, 25 is interconnected to input and output devices and apparatus associated with a process.

The data communications link 28 is preferably a serial link although parallel transmission of signals between the CPU 20 and the I/O modules 24-26 may be readily provided. In either case, I/O modules 24-26 are connected to the communications link 28 for communication with CPU 20. The communications link 28 may comprise a twisted pair of conductors, a coaxial cable, or a fiber optics cable; all are acceptable depending on such considerations as cost and availability.

In FIG. 1, I/O module 24 illustrates in block diagram form the general overall electronic structure of each I/O module.

Thus, there is included a microcontroller 36 having an interface port for exchanging information with CPU 20 and including an associated memory (not illustrated) for implementation of a stored program of operation according to which the various elements of the I/O modules are controlled and diagnosed for incurred faults; a plurality of individual I/O points (or, “I/O circuits”) 37-39, each of which may be selectably operated either as an input point or as an output point and each of which interfaces individually through conductors directly to input or output elements of the controlled process; and a conductor bus 40 for interconnecting the I/O points 37-39 to the microcontroller 36. The number of I/O points 37-39 in any particular I/O module 24-26 depends on practical considerations such as heat dissipation and the limitations of the microcontroller 36. As an example, however, it has been found quite practical and convenient to provide sixteen I/O points per I/O module.

For verifying the integrity and functionality of the input and output components and for maintenance and troubleshooting, monitoring apparatus 42 is provided. The monitor 42 is preferably sized to be hand held so that it can be readily and conveniently moved from one I/O module to the other. It is adapted for connection into each I/O module by a cable which includes a connector for mating with another connector affixed to the I/O module. The cable and mating connectors are schematically illustrated in FIG. 1 which shows the monitor 42 connected to I/O module 24 through an interface port of the microcontroller 36.

When connected to an I/O module, the hand-held monitor 42 allows the I/O points of that module to be monitored and controlled and provides a display of diagnostic information pertaining to the module. Advantageously, the hand-held monitor performs these functions independently of the central processing unit 20 and even without the CPU 20 being present. The monitor 42 is operative for example, to turn output points on and off and to read the state of the input points. In case a fault has occurred, the monitor 42 can also provide an indication of the nature and location of the fault. The hand held monitor 42 may be noted to include a data display panel 44 which displays alpha numeric characters and a set of key switches 46 which provide for address programming and for effecting operation of the I/O modules 24-26.

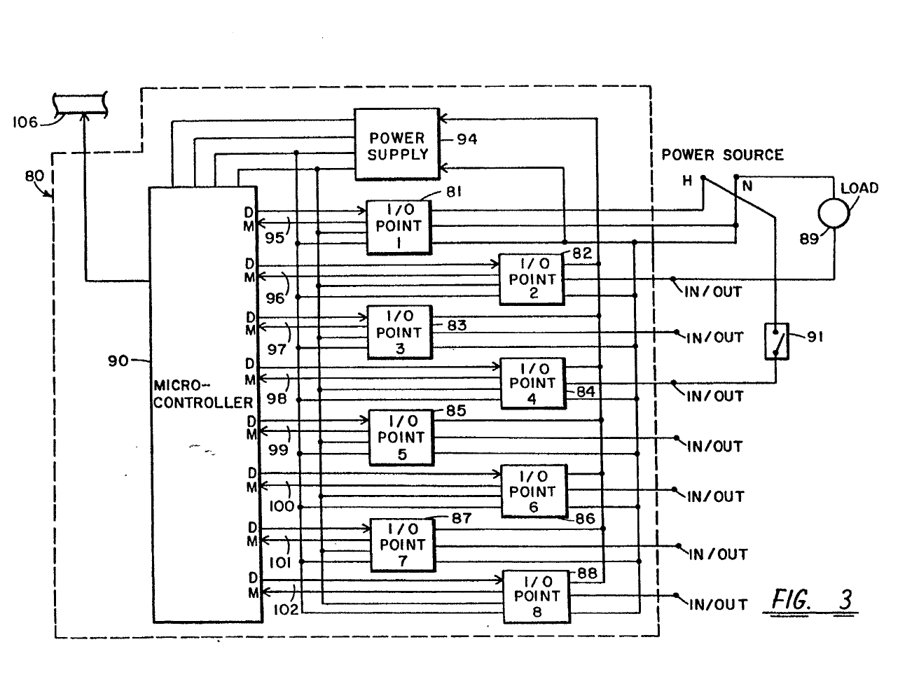

Referring now to FIG. 2, preferred physical forms for a hand-held monitor and an individual I/O module are illustrated. Thus, the illustrated I/O module 51 is substantially in the form of a terminal block which includes a row of conductor terminals 53 for making connection to the conductors that connect with the input and output devices of the controlled process. The terminals 53 may be in the form of screw-type connections in which the screws are tightened down on a connecting wire or terminal lug. Each I/O circuit is assigned to a corresponding terminal connection. In addition, terminals are assigned for connecting an external power source (ac or dc) and for making connections to the data communication link as shown in FIG. 1. Visual indicators are provided, in the form of light emitting diodes (LEDs) 55 to indicate the status of each I/O point. Additional LEDs 57 and 58 provide an indication of the operational status of the module 51. For example, LED 57 indicates that a fault condition is present (either internal or external to the module) and LED 58 indicates normal operating conditions. A connector 59 is provided on the module 51 for mating with a cable connector 60, and, through cable 61 to hand-held monitor 49.

The illustrated hand-held monitor 49, as described above and in connection with FIG. 1, is able to exercise the I/O module to which it is connected. That is, the hand- held monitor allows an I/O module to be operated and thoroughly checked out even if it is not connected to a central processing unit as shown in FIG. 1.

The block diagram of FIG. 3 illustrates an I/O module 80 (substantially the same as any one of modules 24-26 of FIG. 1) in greater detail. The I/O module 80 thus includes a group of 8 separate I/O points 81-88, each one of which exchanges control and diagnostic information signals with microcontroller 90. Electrical power, either ac or dc, is supplied at terminals H and N. The power source connected to terminals H and N provides power both to an internal dc power supply 94 and to any external output loads (e.g., controlled elements) which are controlled by the programmable controller of which module 80 is a part. Power supply 94 is simply the dc power supply for all elements contained in the I/O module 80 which require dc power in their operation.

Each I/O point 81-88 is connected to the microcontroller 90 by a pair of conductors 95-102, respectively. One conductor of each pair, designated the D line, conveys control data to the associated I/O point; the other line, designated the M line, conveys status and diagnostic information from the I/O point to the microcontroller 90. Each I/O point 81-88 is also connected to receive dc power from power supply 94 and each is connected to the power source terminals H and N. If the external power source connected to terminals H and N is a 115 or 230 volt ac line, for example, the H and N terminals merely refer to the hot and neutral sides of the line, respectively. However, if the external power source is dc, the H terminal may be the positive side of the source and the N terminal the negative side. In addition, each I/O module 81-88 includes an IN/OUT terminal which is of dual function. If the I/O point is to be operated as an output point, the IN/OUT terminal for that point is connected to the controlled element (or load) in the process which that point is assigned to control. On the other hand, if the I/O point is to be operated as an input, the IN/OUT line for that point receives the input signal from the input device. The same IN/OUT line thus serves both functions, depending on the command from the microcontroller 90 and the second (or reference) connection of the input or output device. As an example, I/O point 82 is shown operating as an output point, turning power on or off to a load device 89. Load 89 is connected between the IN/OUT line of I/O point 82 and the N line to the power source. By contrast, I/O point 84 is shown operating as an input point with an input switching device 91 connected between the IN/OUT line and the H line of the power source. Any one of I/O points 81-88 may be operated in the output mode either as a dc source, as a dc sink, or as an ac source. That aspect of the circuitry is discussed more fully herein below.

Information provided to the microcontroller 90 from each I/O point 81-88, via the M line connection, includes data reporting the status of load current (high or low), the level of power supplied to that I/O point, the temperature condition of the I/O point, the status of any input device, and still other information, all of which will be set forth in greater detail subsequently herein.

Control of each I/O point 81-88 is ultimately determined by a central processing unit as outlined in connection with FIG. 1. In FIG. 3, communication with such a CPU is through an interface port (preferably a serial port) of microcontroller 90 and through a data communications link 106 (28 of FIG. 1). Other I/O modules substantially similar to module 80 of FIG. 3 may also be connected to the data communications link 106. While microcontroller 90 is responsive to the commands of the central processing unit, it also provides localized, distributed control of each I/O point within the I/O module 80. Microcontroller 90 is an operations control unit and operates in accordance with a stored program and as a function of commands from the central processing unit and the signals received on the M line from each I/O point 81-88. Although not specifically illustrated in FIG. 3, microcontroller 90 also includes memory for program storage and for storage of other data necessary to carry out program execution and to achieve the intended control.

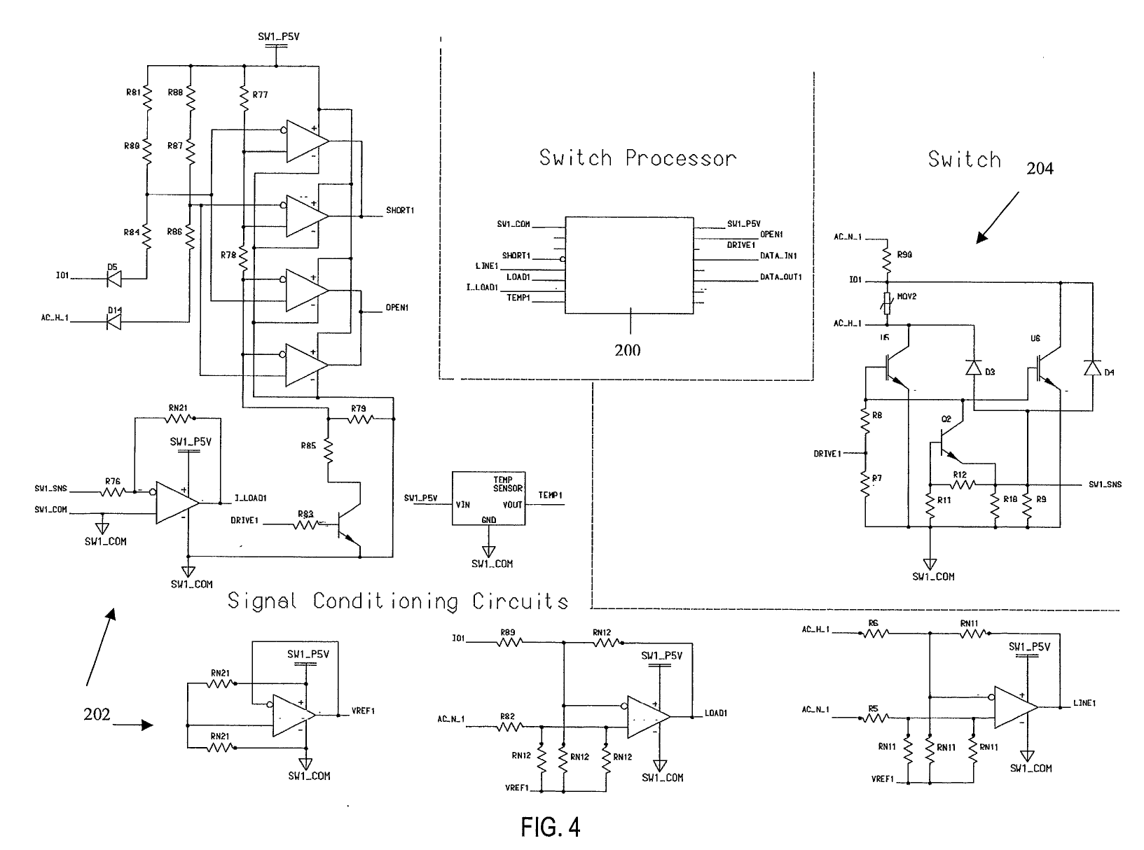

The schematic of FIG. 4 shows a preferred embodiment of an I/O circuit. The I/O point thus includes a switch processor 200, signal conditioning circuits 202, and a primary switching section 204.

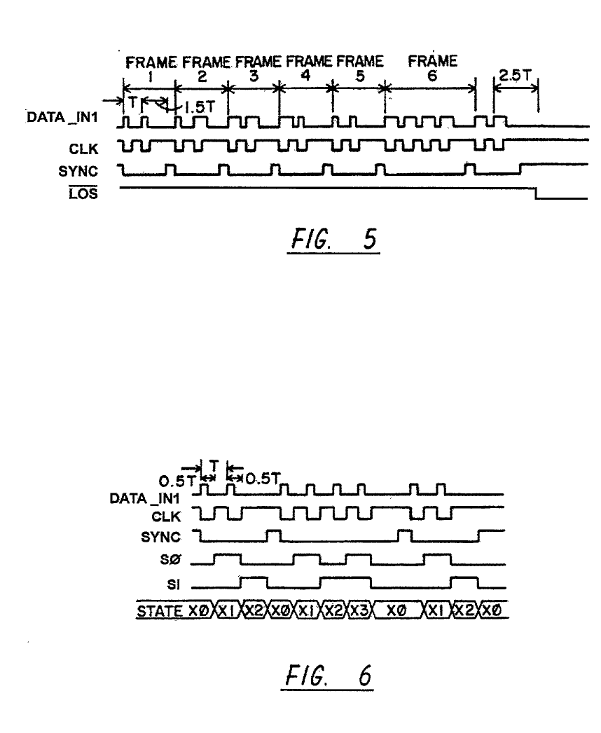

The switch processor 200 receives, on line DATA_IN1 (represented by “D” in FIG. 3), a control signal from the operations control unit (e.g., as from microcontroller 90 of FIG. 3) and transmits a diagnostic signal to the microcontroller on line DATA_OUT1 (represented by “M” in FIG. 3). The command signal contains switch processor mode information and on/off information that is used by the switch processor to control the primary switch section via signal DRIVE1. FIGS. 5 and 6 illustrate the relationship between certain signals involved in the operation of the switch processor communications on lines DATA_IN1 and DATA_OUT1.

The control signal, DATA_IN1, is a coded pulse train containing on/off information (ON/OFF), zero crossing enable (ZERCR), redundant flag enable (RDNT), and timing information (CLK). DATA_IN1 includes of a series of “frames,” each of which contains two to six pulses followed by the omission of a pulse, i.e., a “missing pulse”. The “missing pulse” serves to resynchronize operation of the control and diagnostic signals. Each of the pulses has a duty cycle of either twenty-five or seventy-five percent. The time between pulses within a frame, T, is fixed and is also the time duration of the “missing pulse”. The control signal is initially applied to a timer within the switch processor 200 wherein the rising edge of the signal causes the timer to reset and to initiate its timing cycle. Thus, the timer causes the CLK signal to become active approximately 0.5T after each rising edge of the control signal. The CLK signal is used to latch control data and to update diagnostic data. Unless first reset, the timer also causes a synchronizing signal, SYNC, to become active approximately 1.5T after each rising edge of the control signal. The active SYNC signal resets the communication timing in the switch processor 200 indicating a new frame is about to start.

In addition, unless first reset, a loss of communication signal, LOS, becomes active approximately 1 millisecond after each rising edge of the control signal. The active LOS signal causes the switch processor 200 to turn the primary switch 204 off. Normally, rising edges of the control signal reset the timer before the SYNC and LOS signals become active. However, upon the occurrence of a “missing pulse”, a time 2T occurs between rising edges of the control signal, causing SYNC to become active for approximately 0.5T.

The on/off information passing to the I/O point on line DATA_IN1 is contained in the first two pulses of each frame of the control signal. A seventy-five percent duty cycle pulse corresponds to a logical “1” (switch on) and a twenty-five percent duty cycle corresponds to a logical “0” (switch off). As will become clear, the clock pulse which occurs at 0.5T after the rising edge of a control signal pulse, effectively causes a sampling of the control signal pulse at that time. Thus, if a 25% duty cycle (0.25T) pulse has been transmitted, a low level or “zero” is obtained at 0.5T. On the other hand, if a 75% duty cycle (0.75T) pulse has been transmitted, a high level or “one” is obtained at 0.5T. The first two pulses are also transmitted redundantly: that is, the first two pulses must agree (both 1 or both 0) in order for the switch processor 200 to respond to the ON/OFF command. If the two pulses are different (due, for example, to noise interference), the switch processor 200 maintains the last valid ON/OFF command that was received.

If a frame of the control signal contains more than two pulses, then the third and fourth pulses are used to update the ZERCR and RDNT signals, respectively, and if the fifth and sixth pulses are transmitted, they contain no control information but are used to clock the fifth and sixth pulses of diagnostic information. When ZERCR is set, the zero crossing turn-on and turn-off feature in the switch processor 200 is enabled. In this case, the switch processor 200 waits until a zero crossing of voltage before turning on the switch 204 and a zero crossing of current before turning off the switch. The value of RDNT forces different diagnostic information to be returned on the DATA_OUT1 line. When RDNT is not set, the first diagnostic pulse describes the state of the LOAD_VOLTS signal, and when RDNT is clear the first diagnostic pulse describes the state of the SWITCH_VOLTS signal. Also, when RDNT is set, low line voltage will not generate a fault code in the diagnostic data (diagnostic codes are discussed further infra).

The waveforms of FIG. 5 illustrate the signal relationships control signal, CLK, SYNC, LOS, and the On/Off signal for various conditions. For the first frame (the frames are arbitrarily designated with frame numbers for ease of reference), redundant twenty-five percent duty cycle pulses are sent corresponding to “0” or an Off switch state. Clock pulses are produced at 0.5T after each rising edge of a control signal pulse. Following the two redundant pulses, there is a synchronizing interval or “missing pulse”. The missing pulse causes a SYNC pulse to be produced, signifying the end of a frame. Since the two control signal pulses are both of twenty-five percent duty cycle, the ON/OFF value remains low and the LOS value remains high.

For the second frame, the first control signal pulse is of twenty-five percent duty cycle and the second is of seventy-five percent duty cycle. The lack of identity may result from noise interference, for example. In such case the CLK and SYNC pulses are again produced as in the first frame and LOS remains high. Since the control signal pulses are different, however, the ON/OFF signal retains its previous value, which, in this case is low. In the third frame, the control signal pulses are both of seventy-five percent duty cycle duration, signaling that the ON/OFF switch signal should be raised to the ON level. This occurs at the rising edge of the clock pulse following the second control signal pulse. For the fourth frame, pulse identity is lost between the control pulses and so the on/off line remains high. The fifth frame returns the on/off line to a low level with the occurrence of redundant pulses both having twenty-five percent duty cycles. The sixth frame of control signal pulses includes four seventy-five percent duty cycle pulses. The sixth frame is somewhat extended in time duration to accommodate the four pulses and the “missing pulse”. The first and second control signal pulses return the ON/OFF signal to high. Although not shown, the third pulse of the frame causes ZERCR to go high simultaneously with the rising edge of the resulting clock pulse, and the fourth pulse of the frame causes RDN to go high.

In addition to on/off, ZERCR, and RDNT information, the control signal provides timing for returning status or diagnostic data to the microcontroller. The DATA_OUT1 signal sends out one diagnostic bit for each pulse received on the DATA_IN1 signal. Since there may be two to six pulses, there may be two to six diagnostic bits. The bits are encoded so that the first bit represents whether load voltage is present, the second indicates whether an open load condition is present, the third and fourth bits echo the received ZERCR and RDNT bits (in that order), and the fifth and sixth bits are always set. If a fault condition exists the first and second bits are set, and the remaining four bits indicate the nature of the fault.

The microcontroller 90 (FIG. 3) determines how much information is to be received from the switch processor 200 by the number of pulses per frame contained in the control signal, DATA_IN1, which is sent to the switch processor 200. The microcontroller 90 reads the state signal on line DATA_OUT1 immediately after it puts a rising edge of control signal on the DATA_IN1 line. Thus, the number of pulses per frame in the control signal and the number of status bits read back per frame are the same. Normally, the microcontroller puts out two pulses per frame and reads back X0 and X1. If X0 indicates a fault, the microcontroller 90 then shifts to four or six pulses per frame so that it can read a fault message contained in the X2 and X3 bits. In the absence of a fault, the four or six pulse mode may be used to write the ZERCR and RDNT bits that control the switch processor 200.

The switch processor 200 provides diagnostic data based on inputs from the signal conditioning circuitry and control and state information contained in the switch processor. The six diagnostic signals may be used, for example, to indicate: 1) that there is an open or disconnected load; 2) that load is in excess of a first high limit value requiring an immediate protective response; 3) a load current in excess of a second high limit value requiring a protective response only if the current remains above the limit for some pre-selected time period; 4) that load voltage has, or has not, been applied; 5) the relative level of the supply voltage; and 6) the relative temperature of the power switching device.

Various input/output switching circuits may be provided to be controlled by the gate signal emanating from the switch processor section 200. For example, switching means comprising field effect transistors or silicon controlled rectifiers (SCRs) may be used as the input/output switching circuits. A preferred switching circuit will, in any case, include a means for providing a signal indicative of the current to a connected load. The switching circuits most preferred, however, make use of an insulated gate transistor, or IGT, examples of which are shown in the primary switch section of FIG. 4, such as items U5 and U6.

When the switch is used in a DC source output configuration, the positive side of the DC power source is connected directly to the collector of IGT U5 (the AC_H_1 signal). When the DRIVE1 signal is applied to the gate terminal of IGT's U5 and U6, current will flow from the collector to the emitter, through the parallel combination of R9 and R10 that form a sense resistance, and through diode D4 before flowing to the high-side of a load. The other side of the load is connected to the DC power return. When the switch is used in an AC output configuration, the same thing occurs on the negative half-cycle of the AC power source except that current flows through IGT U6 and diode D3 instead of IGT U5 and diode D4. When the switch is configured as an input, the IGT switch is turned off and an input device switches the external power source to the I01 signal line where a voltage is developed across pre-load resistor R90. Transistor Q2 and biasing resistors R11 and R12 provide a current limiting means for the primary switches so that if the output load presents a short circuit to the switches, transistor Q2 will be activated, which will reduce the DRIVE1 signal causing the switches to limit the amount of current they may pass.

The signal conditioning circuitry monitors the state of the primary switch and provides this information to the switch processor 200 for control and diagnostic reporting purposes. Signals SHORT1 and OPEN1 are the outputs of comparators that are set-up to quickly indicate when a short circuit or open load condition exist in the load circuitry. Both signals are ignored by the switch processor 200 when the switch is turned off. When the switch is turned on, the switch processor begins to monitor the OPEN1 signal and waits a short time to allow the SHORT1 signal to work properly before monitoring it. Then, if the SHORT1 or OPEN1 signals become active, the switch processor quickly turns the switch off and reports an overcurrent fault or an open load fault, respectively, in the diagnostic data.

The I_LOAD1, LOAD1, LINE1, and TEMP1 signals are 0 to 5 volt analog inputs to the switch processor's analog-to-digital converter circuits (claim). These analog signals are converted to digital values by the switch processor 200 once each millisecond and used to perform control operations for the switch and to set diagnostic information. The I_LOAD signal represents the switch current and will set an overcurrent fault and turn off the switch 204 if it exceeds a second threshold within a window of time following the switch being turned on. The first threshold is detected by the SHORT1 signal and causes the switch to be turned off immediately (described above). The second, lower threshold is allowed to exist for a certain amount of time before causing an overcurrent fault. If the switch current exceeds a third threshold, at any time, the switch processor 200 will report an overload diagnostic, but will not turn off the switch 204. These three current thresholds allow the switch 204 to support a relatively large inrush current that lessens over time. The LOAD1 signal represents the voltage at signal IO1, typically the load voltage (can also be the input voltage), with respect to the AC_N_1 signal, which is the AC power source neutral (or may be the DC power source positive or negative terminal depending on the switch application). The LINE1 signal represents the voltage of the external power source. The LOAD1 and LINE1 signal are used by the switch processor 200 to generate the LOAD_VOLTS, SWITCH_VOLTS, and LOW_LINE diagnostic codes. The LOAD_VOLTS diagnostic code is set in the switch processor 200 if the LOAD1 signal is less than 50% of the LINE1 signal. The SWITCH_VOLTS diagnostic code is set in the switch processor 200 if the LOAD1 signal is greater than 10 volts. The LOW_LINE diagnostic is set in the switch processor if the LINE1 signal is less than twenty volts. The TEMP1 signal represents the switch temperature and causes an overtemp fault to be set in the switch processor if the switch temperature exceeds 120 degrees Celsius.

Switch processor 200 advantageously includes firmware to independently process signals and run algorithms using the data represented by the signals as inputs to determine an associated diagnostic code, thus generating the appropriate control response or diagnostic code to be output.

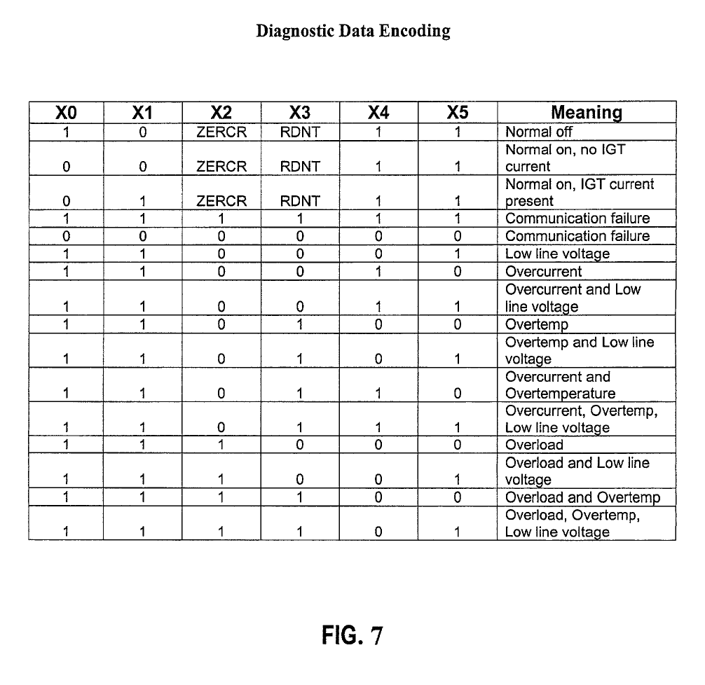

Turning next to FIG. 7, one embodiment of a truth table relating diagnostic and status data to a four bit coded signal for providing combinatorial logic in a state encoder for the switch processor section of FIG. 4 is shown. An encoder in accordance with the truth table of FIG. 7 may readily be implemented with standard combinational logic elements by one of skill in the art having the benefit of this disclosure.

The foregoing describes features of an improved input/output system having utility in connection with programmable controllers. While the best mode contemplated for carrying out the invention has been described, it is understood that various other modifications may be made therein by those of ordinary skill in the art without departure from the inventive concepts inherent in the true invention. Accordingly, it is intended by the following claims to claim all modifications which fall within the true spirit and scope of the invention.

What is claimed is:

1. In an input/output (I/O) system of a programmable controller, a communications method and I/O circuit for exchanging information on control and operating parameters between a controlling element of the I/O system and a controlled element thereof which includes an output control device activated and deactivated in accordance with the control information, comprising the steps of:
a) generating in the controlling element a control signal in the form of sequential pulse frames, each frame having at least one control pulse defining said control information;
b) transmitting said control signal to said controlled element and generating in the controlled element a clock pulse for each control pulse such that said clock pulse follows said control pulse by a pre-selected time interval on each frame, there being one clock pulse for each control pulse such that there is a fixed time relationship between each control pulse and each clock pulse;
c) generating in the controlled element a diagnostic signal independent of the control signal but which is indicative of operating parameters of the controlled element; and
d) using said clock pulse on each frame to cause a sampling of said control information and to cause a transmission of a value of said diagnostic signal to said controlling element;
wherein the I/O circuit comprises a switch processor, a plurality of signal conditioning circuits, and a switch section.

2. The method of claim 1 wherein each frame of the control signal further includes a no-pulse time interval during which no pulses appear defining the end of a frame.

3. The method of claim 2 wherein each frame of said control signal includes a series of pulses defining said control information.

4. The method of claim 3 wherein the series of pulses comprises two to six pulses, followed by the no-pulse time interval.

5. The method of claim 4 wherein the no-pulse time interval comprises a missing pulse for synchronizing the control and diagnostic signals.

6. The method of claim 4, wherein a first two of the two to six pulses are redundant pulses representing an ON/OFF command.

7. The method of claim 6, wherein a third and fourth of said two to six pulses comprise control information.

8. The method of claim 7, wherein a fifth and sixth of said two to six pulses comprise diagnostic information.

9. The method of claim 3 wherein said series of pulses is pulse width modulated.

10. The method of claim 9 wherein said diagnostic signal comprises a multi-bit digital signal and the number of bits transmitted to said controlling element on each frame equals the number of pulses in said series of pulses in the same frame, and wherein the multi-bit digital signal is determined by firmware loaded on the switch processor.

11. An input/output (I/O) circuit comprising a switch processor, a plurality of signal conditioning circuits, and a switch, wherein the switch processor comprises firmware programmed to accept signals from the signal conditioning circuits and a microcontroller as data inputs, and to act upon the information contained in those inputs to control the switch and provide diagnostic information to the microcontroller.

12. The circuit of claim 11, wherein the signals accepted as inputs to the firmware comprise a series of two to six pulses.

13. The circuit of claim 12, wherein the switch processor comprises a zero crossing turn-on and turn-off feature, wherein the switch processor waits until a zero crossing of voltage before turning the switch section on, and a zero crossing of current before turning the switch section off.

14. The circuit of claim 11, wherein the switch processor comprises an analog-to-digital converter circuit for converting signals to a form usable by the firmware.

15. The circuit of claim 14, wherein the switch processor receives a signal representative of the switch section current.

16. The circuit of claim 15, wherein the switch processor causes the switch to be turned off immediately upon detection of a first threshold current level.

17. The circuit of claim 16, wherein the switch processor causes the switch to be turned off after a predetermined period of time during which the switch processor detects a switch current level of a second threshold level, the second threshold level being lower than the first threshold level.

18. The circuit of claim 17, wherein the switch processor reports an overcurrent diagnostic signal, but does not turn off the switch, upon detection of a switch current level of a third threshold level, the third threshold level being lower than the second threshold level.

19. The circuit of claim 11, wherein the firmware of the switch processor generates diagnostic codes for one or more of: over temperature conditions, short circuit conditions, over current conditions, low voltage conditions, and high voltage conditions based on input signals from the conditioning circuits.

20. In an input/output (I/O) system of a programmable controller, an input/output mode comprising:
an operations control unit including a switch processor for providing a control signal in the form of sequential pulse frames, each frame having at least one control pulse defining a desired control status; and
at least one I/O point connected to the operations control unit and having an output control device subject to activation and deactivation as an operative condition in accordance with said control status and further including: (1) timing means responsive to each control pulse to generate a clock pulse which follows said control pulse by a pre-selected time interval on each frame, there being one clock pulse for each control pulse such that there if a fixed time relationship between such pulses; (2) firmware located on the switch processor and connected to the I/O point for providing a diagnostic signal having a value indicative of the operative condition of the I/O point; (3) means connected to receive each clock pulse and responsive to each clock pulse on each frame to cause a sampling of each control pulse to determine the desired control status; and (4) means connected to receive each clock pulse and the diagnostic signal and responsive to said clock pulse on each frame to cause a transmission of a value of said diagnostic signal to the operations control unit.

21. The input/output module of claim 20 wherein said operations control unit provides said control signal such that each frame includes a series of pulses followed by a no-pulse time interval during which no pulses occur, said no-pulse time interval defining the end of a frame.

22. The input/output module of claim 21 wherein at least the first two pulses of each frame are pulse width modulated redundantly to determine the control status.

23. In a programmable controller input/output system of the type having a plurality of input/output modules, each adapted to be located in proximity to a process being controlled, circuitry for use in such modules, comprising:
output control means responsive to be activated and deactivated by a command signal;
an operations controller generating at least one control signal in the form of sequential pulse frames, each frame of which contains at least one pulse defining a control status for the output control means and a time interval without pulses defining the end of the frame whenever said interval reaches a first pre-selected time duration;
a communications and control section receiving said control signal and including firmware responsive to said at least one pulse to provide said command signal for activating and deactivating said output control means in accordance with said control status for each frame and means responsive to said time interval for synchronizing operation of said communications and control section with each frame; sensing means providing status signals indicative of the operative condition of said output control means; and wherein said communications and control section includes a switch processor with on-board firmware coding for receiving said status signals and responsive thereto to produce a diagnostic signal which is updated on each frame of said control signal and first selector means for transmitting said diagnostic signal to said operations controller on each frame of said control signal.

24. The circuitry of claim 23 wherein each frame of said control signal contains a series of pulses defining said control status.

25. The circuitry of claim 24 wherein at least the first two pulses of each frame are pulse width modulated redundantly to determine the command signal for activating and deactivating the output control means.

26. The circuitry of claim 25 wherein said communications and control section further includes second selector means responsive to said time interval to cause said output control means to assume a pre-selected state whenever the time duration of said interval reaches a second pre-selected value.

27. The circuitry of claim 26 further including a plurality of output control means and a corresponding plurality of communications and control sections, and wherein said operations controller generates a plurality of control signals providing one control signal for each communications and control section.
